(19) United States
(12) Patent Application Publication
(10) Pub. No.: US 2007/0117503 A1
(43) Pub. Date: May 24, 2007

(54) AIRFLOW CEILING VENTILATION SYSTEM FOR AN ARMORED TACTICAL PERSONNEL AND COLLECTIVE TRAINING FACILITY

(76) Inventor: Michael F. Warminsky, Ringoes, NJ (US)

Correspondence Address: PATTERSON & SHERIDAN, L.L.P., 3040 POST OAK BOULEVARD, SUITE 1500, HOUSTON, TX, 77056, US

(21) Appl. No.: 11/379,730

(22) Filed: Apr. 21, 2006

Related U.S. Application Data
(63) Continuation-in-part of application No. 11/283,630, filed on Nov. 21, 2005.

(51) Int. Cl. B01L 1/04

(52) U.S. Cl. 454/187

(57) ABSTRACT

The present invention generally relates to a method and apparatus for circulating air through a modular unit configured for live fire training exercises. In one aspect, a modular unit is provided. The modular unit includes a body having an opening formed therein and at least one bullet containment member. The modular unit further includes an active airflow ventilation system disposed on the body and configured to enclose the body and to circulate air through the body. The ventilation system includes a plenum, a ceiling member configured to allow airflow into the plenum and an air control unit configured to circulate the airflow through the plenum. In another aspect, an active airflow ventilation system for use with a shoot house is provided. In yet a further aspect, a method of circulating air through an enclosed modular unit configured for use in live fire training exercises is provided.

### CROSS-REFERENCE TO RELATED APPLICATIONS

This application is a continuation-in-part of U.S. patent application Ser. No. 11/283,630, filed on Nov. 21, 2005, which application is herein incorporated by reference in its entirety.

### BACKGROUND OF THE INVENTION

1. Field of the Invention

Embodiments of the present invention generally relate to a training facility for military and law enforcement personnel. More particularly, embodiments of the present invention relate to an airflow ceiling ventilation system for an armored unit that is used in live fire training exercises.

2. Description of the Related Art

To maintain proficiency in the use of firearms, military and law enforcement personnel engage in target practice. Traditionally, target practice has been conducted on a range in which targets were placed a distance away from the shooter. However, target practice on a range does not adequately train military and law enforcement personnel for many real life situations. Therefore, structures that include ballistic walls in arrangements to resemble a house or other buildings were formed. These structures, typically referred to as shoot houses, enable military and law enforcement personnel to train in situations in which the officer faces realistic threats to their safety.

Traditional shoot houses were originally constructed out of concrete, gravel filled walls, or tire walls. While these shoot houses provided a marked improvement over traditional training at a target range, they still do not feel as realistic as conventional looking walls.

As technology improved, the traditional shoot house has become more sophisticated. Today, as part of most military and law enforcement training scenarios, dynamic encounters, while either moving or against moving “Friend-Foe” targets in realistic settings, are required. Currently, military and law enforcement personnel use a variety of facilities including automated and non-automated static ranges, convoy training structures, and shoot houses to fulfill their training requirements.

Combat veterans and progressive training instructors have acknowledged that the human body and mind have predictable, instinctive responses to surprise and lethal threats. While the basics of weapons handling and marksmanship are important skills for all shooters, they are not the basis for success during most lethal encounters involving the defensive use of a firearm. Trainees are much more likely to be caught off-guard by an aggressive attacker in close quarters and low light conditions than a simulated lethal threat in broad daylight standing 25 yards in front of an earthen berm.

An environment that accurately recreates situational realism is requisite to firearms/tactical training programs, especially with the shift in doctrine to urban training to support the global war on terror and to allow our war fighters to train as they fight. As such, static (non-automated) outdoor ranges with permanent target positions are least desirable to meet the changing mission requirements for these training exercises.

With regard to tactical training, the traditional shoot house is also not fully adequate or desirable due to air quality issues. During live fire training exercises in the traditional shoot, a large amount of smoke is generated due to the live fire. Typically, the traditional shoot house has an open top to allow air flow into the shoot house and exhaust the smoke generated by the live fire. However, even with an open top, air may not adequately circulate through the traditional shoot house, thereby resulting in issues relating to air quality. Additionally, the open top in the traditional shoot house may raise encroachment, nuisance, and/or noise issues.

Therefore, there is a need for an improved shoot house arrangement having a controlled environment. There is a further need for an improved shoot house arrangement having an active airflow ceiling ventilation system. There is yet a further need for an active airflow ceiling ventilation system configured to be placed over an existing traditional shoot house.

### SUMMARY OF THE INVENTION

The present invention generally relates to a method and apparatus for circulating air through a modular unit configured for live fire training exercises. In one aspect, a modular unit is provided. The modular unit includes a body having an opening formed therein and at least one bullet containment member. The modular unit further includes an active airflow ventilation system disposed on the body and configured to enclose the body and to circulate air through the body. The ventilation system includes a plenum, a ceiling member configured to allow airflow into the plenum and an air control unit configured to circulate the airflow through the plenum.

In another aspect, an active airflow ventilation system for use with a shoot house is provided. The active airflow ventilation system includes a plenum comprising a ceiling member and a top portion of the airflow ventilation system. The active airflow ventilation system further includes an air control unit in communication with the plenum and constructed and arranged to maintain airflow through the shoot house. Additionally, the active airflow ventilation system includes a plurality of vents for introducing airflow into the system.

In yet a further aspect, a method of circulating air through an enclosed modular unit configured for use in live fire training exercises is provided. The method includes introducing an airflow into the modular unit via vents disposed in the modular unit, wherein the modular unit includes at least one bullet containment member. The method further includes circulating the airflow through the modular unit. The method also includes urging the airflow through a ceiling member of the modular unit into a plenum, wherein the plenum comprises the ceiling member and a top portion of the modular unit. Additionally, the method includes exhausting the airflow to a location exterior to the modular unit.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a plurality of modular units having an active airflow ventilation system.

FIG. 2 illustrates air circulation through each modular unit.

FIG. 3 illustrates the first floor of the modular units in FIG. 1.

FIG. 4 illustrates the second floor of the modular units in FIG. 1.

FIG. 5 illustrates an airflow ventilation system placed over an existing shoot house.

### DETAILED DESCRIPTION

The present invention is generally directed to a modular unit having an airflow ventilation system. The modular unit is used in live fire training exercises in order to train fighters as they fight. Various terms as used herein are defined below. To the extent a term used in a claim is not defined below, it should be given the broadest definition persons in the pertinent art have given that term, as reflected in printed publications and issued patents. In the description that follows, like parts are marked throughout the specification and drawings with the same reference numerals. The drawings may be, but are not necessarily, to scale and the proportions of certain parts have been exaggerated to better illustrate details and features described below. One of normal skill in the art of shoot houses will appreciate that the various embodiments of the invention can and may be used in all types of shoot houses.

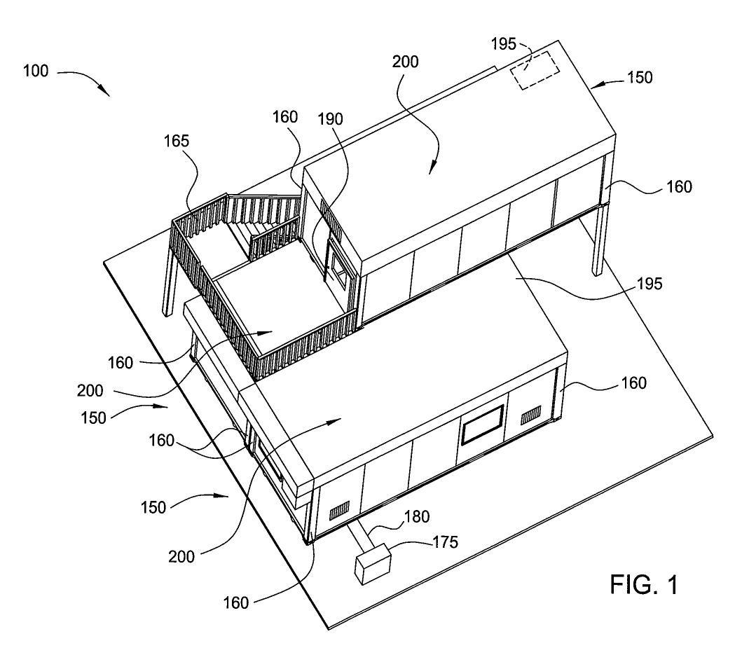

FIG. 1 illustrates a plurality of modular units 150 having an active airflow ventilation system 200. Generally, the airflow ventilation system 200 is used to enclose the modular unit 150 and provide active air circulation through the modular unit 150. As shown, three modular units 150 are configured in a cluster to form a reconfigurable armored tactical personnel and collective training facility (RATPAC) 100. It is to be understood, however, that the RATPAC 100 may include any number of modular units without departing from principles of the present invention. For ease of explanation, the invention will be described generally as it relates to a single building structure. It is to be understood, however, that the invention may be employed in any number of building structures without departing from principles of the present invention.

The modular units 150 in the RATPAC 100 are configured to construct the tactical training facility. Each modular unit 150 is portable and may contain a self-supporting airflow ventilation system 200, thereby allowing the RATPAC 100 to be reconfigured with minimal effort. As shown, each modular unit 150 may be configured with various features, such as widows, doors, stairwells, walls, and hallways, but the overall structure of each modular unit 150 is constructed to a predetermined standard design or structural foot pattern. For instance, each modular unit 150 includes a standard width and a standard length. Additionally, each modular unit 150 includes a support structure 160 at each corner. The standard design allows each modular unit 150 to be arranged in a side by side configuration or in a stacked configuration without substantially modifying the modular unit 150. Additionally, the standard design allows the modular unit 150 to be prefabricated prior to assembly of the RATPAC 100, thereby reducing the design and construction efforts. Another benefit of a standard design is that the modular unit 150 may be disassembled and reconfigured with minimal effort, thereby adding flexibility in modifying training scenarios once erected. In one embodiment, the modular unit is containerized. For instance, the modular unit is built on ISO 9000 container concepts, with foldable frames for flat-pack shipping. In addition, other features, such as an exterior stairway 165 may be added to the RATPAC 100 to create the realistic tactical training facility.

Each modular unit 150 typically includes several subsystems for providing a controlled environment within the modular unit 150. For example, each modular unit 150 includes the airflow ceiling ventilation system 200 for providing airflow ventilation within the modular unit 150. Further, each modular unit 150 may have a subsystem 195, such as closed circuit television (CCT), computer controlled targetry arrangement, sound effects, and power. Typically, each subsystem is integral to the modular unit 150 and is connected via an umbilical cord 180 to a central control module in a control room 175. In another embodiment, each modular unit 150 is connected to the control room 175 through a wireless network. The subsystems may also be connected to an after action review (AAR)/classroom space, as well as mechanical/electrical units that are configured to meet each application's requirements. The subsystem arrangement allows the modular unit 150 to be mobile and affords the end-user a plug and play product.

Generally, each modular unit 150 includes interior and exterior panels that consist of standard dimension panels mounted on a grid system, and includes solid panels (single and double sided), window panels, and door panels, with or without breach capabilities. In one embodiment, the doors and the windows in each modular unit 150 include bullet resistant material. The interior of each modular unit 150 includes bullet containment walls or bullet containment members configured to allow live-fire within the modular unit 150. More specifically, the walls in each modular unit 150 include armored panels and/or armored steel plates to maintain the integrity of the walls when rounds of bullets are shot in the modular unit 150. In one embodiment, the bullet containment members include a material, such as rubber or plastic, which is constructed and arranged to absorb and contain rounds of bullets generated by the live fire exercises. In another embodiment, the bullet containment members may include bullet resistant material. The exterior facades of each modular unit 150 can also be mounted on the grid system to provide additional realism when the RATPAC 100 training facility is used as part of a Military Operations on Urban Terrain (MOUT) or Combined Arms Collective Training Facility (CACTF) to simulate the desired objective. Additionally, the exterior of each modular unit 150 may include brick and mortar to create a realistic tactical training facility. In another embodiment, the modular unit 150 may be configured for simulated munitions, such as paintballs. In this embodiment, the lightweight walls may be used in place of the bullet containment walls.

The RATPAC 100 may include the capability of integral breaching walls 185 and doors 190 to gain entry to the modular unit 150 and/or individual rooms to add realism to the training session. The interior and exterior “breach panels” simulating walls 185 and doors 190 are substituted for the standard armor panels, at predetermined entry points, allowing for demolition effects simulator (DES) or mechanical breaching techniques without damaging the modular unit 150. In addition, each modular unit 150 offers the added realism of traditional height ceilings and an airflow ceiling ventilation system, thereby reducing the Surface danger Zone (SDZ) footprint and encroachment or noise issues. Further, each modular unit 150 includes room sizes that can be configured to match the required tactical scenario, as well as flexibility afforded by portable target systems that are easily relocated/reprogrammed to change training scenarios.

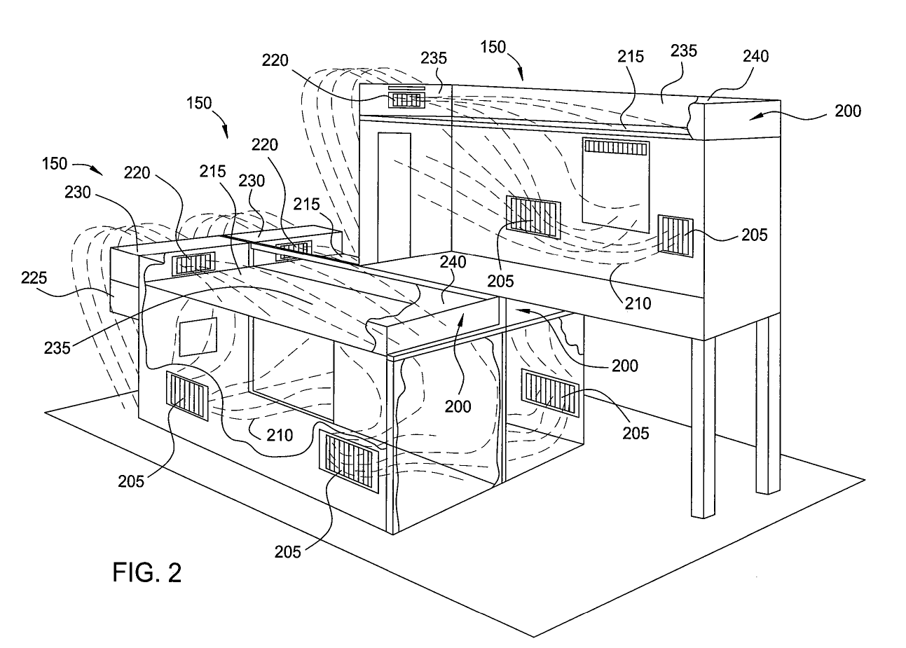

FIG. 2 illustrates air circulation through each modular unit 150. For clarity, some components in the RATPAC 100 in FIG. 1 are not shown. As illustrated, each modular unit 150 includes an individual airflow ventilation system 200 integrated therein. Alternatively, the modular units 150 may have a common airflow ventilation system 200. The airflow ventilation system 200 typically includes armored panels and/or armored steel plates to maintain the integrity of the ceiling when rounds of bullets are shot in the modular unit 150.

The airflow ventilation system 200 includes a plurality of vents 205 disposed in each modular unit 150. The vents 205 are constructed and arranged to allow air from a location outside each modular unit 150 to enter the modular unit 150 to a location inside each modular unit 150. The vents 205 may include armored panels and/or armored steel plates to maintain the integrity of the walls when rounds of bullets are shot in the modular unit 150. The vents 205 may also include a filtering member disposed therein for filtering the air entering the modular unit 150.

The airflow ventilation system 200 further includes a ceiling member 215. The ceiling member 215 is generally used to act as a structural ceiling in the modular unit 150 and as a means to allow the airflow 205 into a plenum 235. The ceiling member 215 may be fabricated from any type of material that is capable of providing a rigid structural member, such as plastic, wood, metal, or mineral fiber material. In one embodiment, the ceiling member 215 includes a plurality of perforations, wherein the perforations are configured to allow airflow through the ceiling member 215. The ceiling member 215 may also include a plurality of ridges formed therein to increase the surface area of the ceiling member 215, thereby allowing more airflow through the ceiling member 215. Additionally, the ceiling member 215 may include an elastomeric coating.

As illustrated, the plenum 235 includes the ceiling member 215 and a top portion 240 of the airflow ventilation system 200. Generally, the plenum 235 is an enclosed portion of the modular unit 150 designed to allow air movement, and thereby serve as part of an air distribution system. The plenum 235 is configured to move the airflow 210 under a slight positive pressure. Although the plenum 235 in FIG. 1 is shown as a ceiling plenum, the plenum 235 may be located at any position in the modular unit 150, without departing from principles of the present invention. For instance, the plenum 235 may be located in a wall or a floor of the modular unit 150.

As shown in FIG. 2, the plenum 235 is in communication with an extract plenum 230 via air vent 220 for each lower modular unit 150 and the plenum 235 is in communication with an exterior location via air vent 220 for the upper modular unit 150. The extract plenum 230 is configured to communicate the airflow 210 a location that is outside of the modular unit 150. In one embodiment, the extract plenum 230 is connected to an exhaust fan (not shown).

The airflow ventilation system 200 further includes an air control unit 225 constructed to maintain the air circulation through the modular unit 150. The air control unit 225 may be configured to produce and circulate cold air or heated air through the modular unit 150. In the embodiment shown in FIG. 2, the air control unit 225 is attached to the extract plenum 230. It should be understood, however, that the air control unit 225 may be disposed at any location relative to the modular unit 150, without departing from principles of the present invention. Additionally, the air control unit 225 includes a control mechanism (not shown) to control the amount of air circulation through the modular unit 150. In one embodiment, the airflow ventilation system 200 includes a sensor (not shown) disposed in the modular unit 150. The sensor is configured to work with the air control unit 225. The sensor may be used to measure temperature, pressure and/or airflow in the modular unit 150.

The airflow ventilation system 200 generally operates in the following manner. Airflow 210 enters into the modular unit 150 via the vents 205. Next, the airflow 210 travels through the modular unit 150 and subsequently toward the ceiling member 215. The airflow 210 then moves through the ceiling member 215 and into the plenum 235 due to a slight positive pressure created by the air control unit 225. Thereafter, the airflow 210 exits the plenum 235 via air vent 220. Finally, the airflow 210 is exhausted to a location that is external to the modular unit 150 via the extract plenum 235 or through the air vent 220.

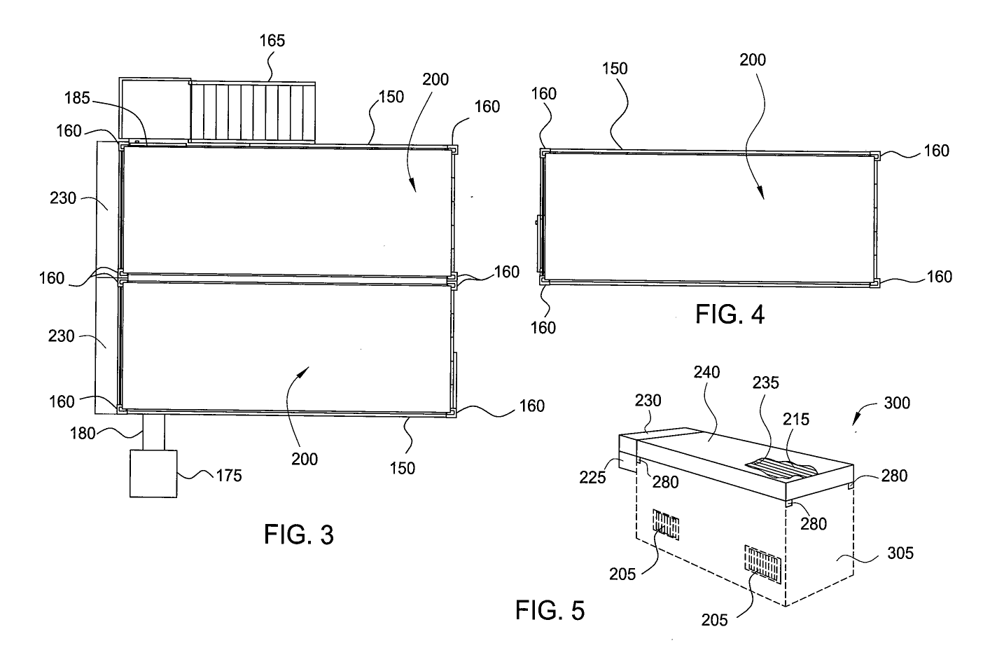

FIG. 3 illustrates the first floor of the RATPAC 100 in FIG. 1 and FIG. 4 illustrates the second floor of the RATPAC 100 in FIG. 1. As shown in FIG. 3, the RATPAC 100 includes two modular units 150 side by side and as shown in FIG. 4 a single modular unit 150 on the second floor. As clearly shown in FIGS. 3 and 4, each modular unit 150 has the same exterior dimensions. In other words, each modular unit 150 has the same structural footprint, thereby allowing the modular unit 150 to be arranged in numerous configurations. As previously described, each modular unit 150 includes a number of subsystems that are interconnected with other modular units to form a single unit. The single unit is connected to the control room 175 via the cord 180, thereby allowing the single unit to be controlled at one location.

Although the RATPAC 100 in FIGS. 1-4 illustrates a three module unit arrangement, the RATPAC 100 is scaleable from a single module arrangement to a multiple module arrangement with practically limitless floor plan possibilities. The RATPAC 100 may also be configured as an indoor range by positioning the modular units 150 end to end long-ways to make a single story range, such as a 25 meter range. Additionally, the RATPAC 100 may be configured as a high rise building arrangement with multiple stories, thereby allowing the integration of rappelling and tactical training in a realistic setting using a single facility. As discussed herein, each modular unit 150 of the RATPAC 100 may have an individual airflow ventilation system 200 or each modular unit 150 may share a combined airflow ventilation system 200. Furthermore, the RATPAC 100 may include interior/exterior stairs and balconies, rappel points, and large open rooms to create a realistic tactical training facility.

In one embodiment, multiple RATPAC 100 buildings may be combined to create a live-fire Combined Arms Collective Training Facility (CACTF) capable of providing culminating urban operations training that was previously accomplished through an Urban Assault Course, a Shoot House, and Breach Facilities separately. A CACTF constructed using modular units 150 allows multiple units to train simultaneously on the collective tasks of breaching, tactical movement, target engagement and discrimination, building entry, and room clearance in a live-fire environment, wherein each modular unit 150 includes a bullet containment frame. Additionally, the multi-story RATPAC buildings can be constructed with rooftop over watch positions to allow the incorporation of elements such as command and control and security into the aforementioned live-fire training scenarios.

To develop an appropriate configuration to meet specific mission/training scenario requirements, 3 dimensional (3-D) computer simulations are conducted. Commercially available engineering architectural software, enhanced with proprietary programming, enables construction and viewing of the facility in a virtual world from a site perspective. Walk-thoughs, fly-overs, and rotational views through 3-D animation enable the trainer to review the “completed” facility early in the design phase, to ensure targetry location, functionaility, and training realism prior to finalizing the site detail design and tendering construction.

FIG. 5 is a view illustrating an airflow ventilation system 300 placed on an existing shoot house 305. For convenience, components in FIG. 5 that are similar to components in FIG. 2 will be labeled with the same number indicator. As illustrated, the airflow ventilation system 300 includes the vents 205 and the plenum 235 defined between the ceiling member 215 and the top portion 240 of the airflow ventilation system 300. The airflow ventilation system 300 further includes the extract plenum 235 and the air control unit 225.

The airflow ventilation system 300 also includes a plurality of connection members 280 disposed at the corners of the airflow ventilation system 300. The connection members 280 are configured to connect the airflow ventilation system 300 to the existing shoot house 305. In one embodiment, the connection member 280 is a plate member with fastener member, such as a bolt. It should be understood, however, that the connection member 280 may be any type of connection arrangement known in the art. Furthermore, although the airflow ventilation system 300 in FIG. 5 shows three connection members 280 attached thereto, any number of connection members 280 may be attached to the airflow ventilation system 300, without departing from principles of the present invention. Additionally, the airflow ventilation system 300 may include a seal member (not shown), such as an elastomer, for use in creating a sealing relationship between the airflow ventilation system 300 and the shoot house 305.

While the foregoing is directed to embodiments of the present invention, other and further embodiments of the invention may be devised without departing from the basic scope thereof, and the scope thereof is determined by the claims that follow.

1. A modular unit for use in live fire training exercises, comprising:
a body having at least one opening formed therein and at least one bullet containment member; and
an active airflow ventilation system disposed on the body and configured to enclose the body and to circulate air through the body, the ventilation system comprising:
a plenum;
a ceiling member configured to allow airflow into the plenum; and
an air control unit configured to circulate the airflow through the plenum.

2. The modular unit of claim 1, wherein the plenum comprises the ceiling member and a top portion of the airflow ventilation system.

3. The modular unit of claim 2, wherein the top portion of the airflow ventilation system includes at least one bullet containment member.

4. The modular unit of claim 1, wherein the ceiling member includes a plurality of perforations formed therein to allow airflow therethrough.

5. The modular unit of claim 1, wherein the airflow ventilation system includes an extract plenum in communication with the plenum and configured to communicate the airflow to an exterior location of the modular unit.

6. The modular unit of claim 1, wherein the ceiling member includes a plurality of ridges formed therein to increase the airflow through the ceiling member.

7. The modular unit of claim 6, wherein the body is configured to be connectable with another modular unit.

8. The modular unit of claim 1, wherein the airflow ventilation system includes at least one vent disposed in a wall of the body.

9. The modular unit of claim 8, wherein the at least one vent is constructed from armored steel members.

10. An active airflow ventilation system for use with a shoot house, comprising:
a plenum comprising a ceiling member and a top portion of the airflow ventilation system;
an air control unit in communication with the plenum and constructed and arranged to maintain airflow through the shoot house; and
a plurality of vents.

11. The active airflow ventilation system of claim 10, wherein the ceiling member includes a plurality of perforations configured to allow airflow into the plenum.

12. The active airflow ventilation system of claim 10, further including at least one connection member constructed and arranged to connect the airflow ventilation system to the shoot house.

13. The active airflow ventilation system of claim 10, further including at least one bullet containment member.

14. The active airflow ventilation system of claim 11, further including an extract plenum in communication with the plenum and configured to communicate the airflow to a location exterior to the shoot house.

15. The active airflow ventilation system of claim 11, further including a control member for manipulating the amount of airflow.

16. A method of circulating air through an enclosed modular unit configured for use in live fire training exercises, comprising:
introducing an airflow into the modular unit via vents disposed in the modular unit, wherein the modular unit includes at least one bullet containment member;
circulating the airflow through the modular unit;
urging the airflow through a ceiling member of the modular unit into a plenum, wherein the plenum comprises the ceiling member and a top portion of the modular unit; and
exhausting the airflow to a location exterior to the modular unit.

17. The method of claim 16, further comprising circulating the airflow through an extract plenum that is connected to the plenum.

18. The method of claim 16, wherein the ceiling member includes a plurality of perforations configured to allow airflow into the plenum.

19. The method of claim 16, further comprising controlling the amount of airflow circulating through the modular unit.

20. The method of claim 16, further comprising filtering the airflow in the modular unit.
